(19) United States
(12) Patent Application Publication
(10) Pub. No.: US 2026/0122684 A1
(43) Pub. Date: Apr. 30, 2026

(54) APPARATUS, SYSTEM, AND METHOD OF BEACON TRANSMISSION TIME SHIFT

(71) Applicant: Intel Corporation, Santa Clara, CA (US)

(72) Inventors: Ido Ouzieli, Tel Aviv (IL); Emmanuel Grumbach, Jerusalem (IL); Laurent Cariou, Milizac (FR)

(73) Assignee: Intel Corporation, Santa Clara, CA (US)

(21) Appl. No.: 19/432,612

(22) Filed: Dec. 24, 2025

Related U.S. Application Data
(60) Provisional application No. 63/766,794, filed on Mar. 4, 2025.

(51) Int. Cl. H04W 74/0816; H04W 74/04

(52) U.S. Cl. CPC H04W 74/0816; H04W 74/04

(57) ABSTRACT

For example, a non Access Point (AP) (non-AP) station (STA) may be configured to set one or more fields of a frame to configure a beacon transmission time shift request for an AP, the beacon transmission time shift request configured to request the AP to shift a timing of a beacon transmission sequence of the AP; and to transmit the frame to the AP. For example, the AP may be configured to transmit a plurality of beacons according to a timing of a beacon transmission sequence of the AP; to process one or more fields of the frame received from the non-AP STA to determine the beacon transmission time shift request from the non-AP STA; and, based on a determination that the beacon transmission time shift request from the non-AP STA is to be accepted, shift the timing of the beacon transmission sequence of the AP.

### CROSS REFERENCE

This Application claims the benefit of and priority from U.S. Provisional Patent Application No. 63/766,794 entitled “ENABLING BEACON RECEPTION UNDER HIDDEN-NODE SCENARIOS”, filed Mar. 4, 2025, the entire disclosure of which is incorporated herein by reference.

### BACKGROUND

Devices in a wireless communication system may be configured to communicate various types of frames, which may include, for example, beacon frames, data frames, control frames, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a structure of a beacon transmission time shift request Information Element (IE), in accordance with some demonstrative aspects.

FIG. 3 is a schematic illustration of a structure of a beacon-shift element, in accordance with some demonstrative aspects.

FIG. 4 is a schematic flow-chart illustration of a method of a beacon transmission time shift, in accordance with some demonstrative aspects.

FIG. 5 is a schematic flow-chart illustration of a method of a beacon transmission time shift, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2024, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, April 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stack, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink (UL) frames using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

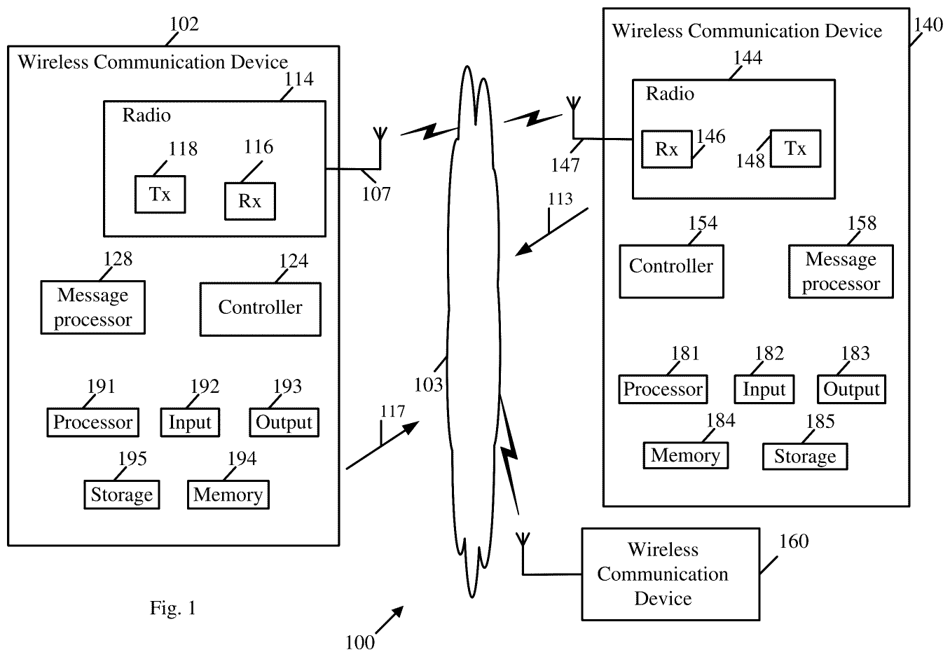

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to implement one or more operations and/or functionalities of a beacon transmission time shift mechanism, which may be configured to support a request from a non-AP STA to an AP to shift a timing of a beacon transmission sequence of the AP, e.g., as described below.

In some demonstrative aspects, device 102, device 140, and/or device 160 may be configured to implement one or more operations and/or functionalities of a beacon transmission time shift mechanism, which may be configured to provide a technical solution to enable the non-AP STA to receive beacons from the AP, for example, in one or more scenarios, e.g., as described below.

In some demonstrative aspects, device 102, device 140, and/or device 160 may be configured to implement one or more operations and/or functionalities of a beacon transmission time shift mechanism, which may be configured to provide a technical solution to support the non-AP STA to receive beacons from the AP, for example, when beacon transmissions from other APs collide with the beacons from the AP, e.g., as described below.

In some demonstrative aspects, device 102, device 140, and/or device 160 may be configured to implement one or more operations and/or functionalities of a beacon transmission time shift mechanism, which may be configured to provide a technical solution to support the non-AP STA to receive beacons from the AP, for example, in hidden-node scenarios, e.g., as described below.

In some demonstrative aspects, a hidden-node scenario may include a scenario, in which first transmissions from a first AP and second transmissions from a second AP may collide with each other.

In some demonstrative aspects, the first transmissions from the first AP and the second transmissions from the second AP may collide with each other, for example, when the first AP and the second AP do not hear each other, and as a result, transmit their beacons simultaneously.

In some demonstrative aspects, hidden-node scenarios may occur more frequently, for example, as Wi-Fi usage becomes more popular and a number of APs in specific locations increases.

In one example, a non-AP STA, e.g., a Wi-Fi client, which is located between the first AP and the second AP and associated with the first AP, may have reception issues, e.g., serious reception issues, in a hidden-node scenario. For example, Rx traffic from the first AP to which the non-AP STA is associated may collide with Rx traffic from the second AP. For example, as a result, the Rx traffic from the second AP, which may not be ‘interesting’ to the non-AP STA, may prevent reception of the Rx traffic from the first AP, which may be ‘interesting’ for the non-AP STA.

In some demonstrative aspects, the beacon transmission time shift mechanism may be configured to provide a technical solution to support hidden-node scenarios, for broadcast transmissions, e.g., beacon transmissions, in which first beacon transmissions from a first AP and second beacon transmissions from a second AP may collide with each other.

In one example, hidden-node scenarios for unicast transmissions may be avoided, for example, by using an acknowledgement (ACK) mechanism. For example, the ACK mechanism may define that a client may not ACK traffic from an AP, for example, when the client does not receive the traffic from the AP.

According to this example, the client may not send an Ack when the client does not receive the traffic from the AP and, accordingly, the AP may understand that its traffic was not received by the client, and may re-transmit the traffic. For example, the ACK mechanism may solve the hidden-node scenario problem for unicast transmissions, e.g., even if not ideally.

In another example, hidden-node scenarios for unicast transmissions may be avoided, for example, by using a Request To Send (RTS)/Clear To Send (CTS)/(RTS-CTS) mechanism. For example, the RTS-CTS mechanism may solve the hidden-node scenario problem, for example, in cases where transmissions are performed by the client. However, the RTS-CTS mechanism may not be applicable for transmissions performed by the AP.

In some demonstrative aspects, the RTS-CTS mechanism and/or the ACK mechanism may not be applicable for broadcast transmissions, e.g., beacon transmission from an AP.

For example, APs, e.g., a first AP and a second AP, may typically transmit beacons every predefined period, e.g., every 100 Time Units (TUs). According to this example, if the first AP and the second AP transmit their beacons at the same time, e.g., a situation which may be statistically possible, the beacons may repeatedly collide. For example, a client, which may be associated with one of the first AP and the second AP, and may be located between the first AP and the second AP, may not be able to receive beacons from the associated AP.

In some demonstrative aspects, beacon collisions may not happen immediately, for example, but rather after a certain period, for example, due to internal drifts of clocks of the APs.

In some demonstrative aspects, the beacon collisions may start occurring, and may then disappear after a certain period of time, for example, due to the internal clock drifts of the APs.

In some demonstrative aspects, the beacon transmission time shift mechanism may be configured to provide a technical solution to support reducing, or even eliminating, the beacon collisions, which may be a serious issue, for example, as beacons may include crucial information for sustaining a connection between an AP and a client, e.g., an operational BW, regulatory information, a channel load, a channel-switch, and/or the like.

In some demonstrative aspects, device 102, device 140, and/or device 160 may be configured to implement one or more operations and/or functionalities of a beacon transmission time shift mechanism, which may be configured to support a request from a non-AP STA to an AP to shift a timing of a beacon transmission sequence of the AP, for example, when the non-AP station identifies a hidden-node scenario that causes beacons from APs to collide, e.g., as described below.

In some demonstrative aspects, the beacon transmission time shift mechanism may be configured to provide a technical solution to support a wireless network including two or more APs to overcome a hidden-node scenario with the help of a non-AP STA, e.g., a client, which is associated with one of the APs, e.g., as described below.

In some demonstrative aspects, controller 154 may be configured to control, trigger, cause, and/or instruct a non-AP STA implemented by device 140 to set one or more fields of a frame 113 to configure a beacon transmission time shift request for an AP, e.g., an AP 102 implemented by device 102, e.g., as described below.

In some demonstrative aspects, the beacon transmission time shift request may be configured to request the AP 102 to shift a timing of a beacon transmission sequence of the AP 102, e.g., as described below.

In some demonstrative aspects, controller 154 may be configured to control, trigger, cause, and/or instruct the non-AP STA implemented by device 140 to transmit the frame 113 to the AP 102, e.g., as described below.

In some demonstrative aspects, the beacon transmission sequence of the AP 102 may include a sequence of beacons scheduled at a respective sequence of Target Beacon Transmission Times (TBTTs), e.g., as described below.

In some demonstrative aspects, two consecutive TBTTs in the sequence of TBTTs may be separated by a beacon interval, e.g., as described below.

In some demonstrative aspects, the frame 113 may include a protected action frame, e.g., as described below.

In other aspects, the frame 113 may include any other type of frame.

In some demonstrative aspects, the frame 113 may include a beacon transmission time shift request Information Element (IE) including the one or more fields to configure the beacon transmission time shift request, e.g., as described below.

In some demonstrative aspects, controller 154 may be configured to control, trigger, cause, and/or instruct the non-AP STA implemented by device 140 to set the one or more fields of the frame 113 to include a duration value in a duration field, e.g., as described below.

In some demonstrative aspects, the duration value may be configured to indicate a requested time shift duration of a time shift to be applied to the timing of the beacon transmission sequence of the AP 102, e.g., as described below.

In some demonstrative aspects, the requested time shift duration may be no longer than half of a beacon interval of the beacon transmission sequence of the AP 102, e.g., as described below.

In some demonstrative aspects, controller 154 may be configured to control, trigger, cause, and/or instruct the non-AP STA implemented by device 140 to set the one or more fields of the frame 113 to include a minimal duration value in a minimal duration field, e.g., as described below.

In some demonstrative aspects, the minimal duration value may be configured to indicate a requested minimal time shift duration of a time shift to be applied to the timing of the beacon transmission sequence of the AP 102, e.g., as described below.

In some demonstrative aspects, controller 154 may be configured to control, trigger, cause, and/or instruct the non-AP STA implemented by device 140 to set the one or more fields of the frame 113 to include a maximal duration value in a maximal duration field, e.g., as described below.

In some demonstrative aspects, the maximal duration value may be configured to indicate a requested maximal time shift duration of the time shift to be applied to the timing of the beacon transmission sequence of the AP 102, e.g., as described below.

In some demonstrative aspects, controller 154 may be configured to control, trigger, cause, and/or instruct the non-AP STA implemented by device 140 to set the one or more fields of the frame 113 to include a priority value in a priority field, e.g., as described below.

In some demonstrative aspects, the priority value may be configured to indicate a priority level of the beacon transmission time shift request, e.g., as described below.

In some demonstrative aspects, controller 154 may be configured to control, trigger, cause, and/or instruct the non-AP STA implemented by device 140 to process a broadcast frame from the AP 102, or example, to identify an AP-decided time shift, e.g., decided by AP 102, to be applied to the timing of the beacon transmission sequence of the AP 102, e.g., as described below.

In some demonstrative aspects, controller 154 may be configured to control, trigger, cause, and/or instruct the non-AP STA implemented by device 140 to process a received beacon 117 from the AP 102, for example, to identify a beacon-shift element, e.g., as described below.

In some demonstrative aspects, controller 154 may be configured to control, trigger, cause, and/or instruct the non-AP STA implemented by device 140 to determine an AP-decided time shift, e.g., decided by AP 102, to be applied to the timing of the beacon transmission sequence of the AP 102, for example, based on a time shift field in the beacon-shift element, e.g., as described below.

In some demonstrative aspects, controller 154 may be configured to control, trigger, cause, and/or instruct the non-AP STA implemented by device 140 to determine a number of beacon-intervals until the AP 102 is to apply the AP-decided time shift, for example, based on a number-of beacon-intervals field in the beacon-shift element, e.g., as described below.

In some demonstrative aspects, the beacon transmission time shift request may include a beacon transmission delay request, which may be configured to request the AP 102 to delay the timing of the beacon transmission sequence of the AP 102, e.g., as described below.

In some demonstrative aspects, the beacon transmission time shift request may include a beacon transmission advance request, which may be configured to request the AP 102 to advance the timing of the beacon transmission sequence of the AP 102, e.g., as described below.

In some demonstrative aspects, controller 154 may be configured to control, trigger, cause, and/or instruct the non-AP STA implemented by device 140 to determine whether a beacon transmission time shift is to be requested from the AP 102, for example, based on one or more criteria, e.g., as described below.

In some demonstrative aspects, controller 154 may be configured to control, trigger, cause, and/or instruct the non-AP STA implemented by device 140 to determine whether a beacon transmission time shift is to be requested from the AP 102, for example, based on one or more unreceived beacons from the AP 102, e.g., as described below.

In other aspects, controller 154 may be configured to control, trigger, cause, and/or instruct the non-AP STA implemented by device 140 to determine whether a beacon transmission time shift is to be requested from the AP 102, for example, based on one or more additional or alternative criteria.

In some demonstrative aspects, the one or more unreceived beacons from the AP 102 may include one or more beacons which are scheduled to be received by the non-A STA implemented by device 140 from the AP 102 according to the beacon transmission sequence of the AP 102, and which are not successfully received by the non-A STA implemented by device 140, e.g., as described below.

In some demonstrative aspects, controller 154 may be configured to control, trigger, cause, and/or instruct the non-AP STA implemented by device 140 to, based on a determination that the beacon transmission time shift is to be requested, transmit the frame 113 including the one or more fields set to indicate the beacon transmission time shift request, e.g., as described below.

In some demonstrative aspects, controller 154 may be configured to control, trigger, cause, and/or instruct the non-AP STA implemented by device 140 to determine whether the beacon transmission time shift is to be requested from the AP 102, for example, according to a hidden-node criterion, which may be applied with respect to the one or more unreceived beacons from the AP 102, e.g., as described below.

In some demonstrative aspects, the hidden-node criterion may be configured to result in the determination that the beacon transmission time shift is to be requested, for example, when the one or more unreceived beacons from the AP 102 are not successfully received by the non-A STA implemented by device 140, for example, due to collision with transmissions from another AP, for example, an AP implemented by device 160, e.g., as described below.

In some demonstrative aspects, controller 154 may be configured to control, trigger, cause, and/or instruct the non-AP STA implemented by device 140 to determine that the beacon transmission time shift is to be requested, for example, based on a determination that one or more non-beacon transmissions from the AP 102 are successfully received by the non-AP STA during a time interval between an unreceived beacon from the AP 102 and a time of an expected beacon adjacent to the unreceived beacon in the beacon transmission sequence of the AP 102, e.g., as described below.

In some demonstrative aspects, the one or more non-beacon transmissions from the AP 102 may include one or more data frames from the AP 102, e.g., as described below.

In some demonstrative aspects, the one or more non-beacon transmissions from the AP 102 may include one or more Acknowledge (Ack) frames, for example, to Acknowledge an uplink transmission from the non-A STA implemented by device 140 to the AP 102, e.g., as described below.

In other aspects, the one or more non-beacon transmissions from the AP 102 may include any other additional and/or alternative type of frames.

In some demonstrative aspects, controller 154 may be configured to control, trigger, cause, and/or instruct the non-AP STA implemented by device 140 to determine that the beacon transmission time shift is not to be requested, for example, based on a determination that one or more expected non-beacon transmissions from the AP 102 are not successfully received by the non-AP STA during the time interval between the unreceived beacon from the AP 102 and the time of the expected beacon adjacent to the unreceived beacon in the beacon transmission sequence of the AP 102, e.g., as described below.

In some demonstrative aspects, the one or more expected non-beacon transmissions from the AP 102 may include one or more data frames from the AP 102, e.g., as described below.

In some demonstrative aspects, the one or more expected non-beacon transmissions from the AP 102 may include one or more Ack frames, for example, to Acknowledge an uplink transmission from device the non-A STA implemented by 140 to the AP 102, e.g., as described below.

In other aspects, the one or more expected non-beacon transmissions from the AP 102 may include any other additional and/or alternative type of frames.

In some demonstrative aspects, controller 154 may be configured to control, trigger, cause, and/or instruct the non-AP STA implemented by device 140 to set the one or more fields of the frame 113, for example, based on a requested time shift duration of a time shift to be applied to the timing of the beacon transmission sequence of the AP 102, e.g., as described below.

In some demonstrative aspects, controller 154 may be configured to control, trigger, cause, and/or instruct the non-AP STA implemented by device 140 to determine the requested time shift duration, for example, based on the one or more unreceived beacons, e.g., as described below.

In some demonstrative aspects, controller 154 may be configured to control, trigger, cause, and/or instruct the non-AP STA implemented by device 140 to determine the requested time shift duration, for example, based on a count of the one or more unreceived beacons, e.g., as described below.

In some demonstrative aspects, controller 154 may be configured to control, trigger, cause, and/or instruct the non-AP STA implemented by device 140 to determine the requested time shift duration, for example, based on a count of a plurality of successive unreceived beacons, e.g., as described below.

In some demonstrative aspects, controller 154 may be configured to control, trigger, cause, and/or instruct the non-AP STA implemented by device 140 to determine the requested time shift duration, for example, based on an unsuccessfully processed portion of an unreceived beacon, e.g., as described below.

In some demonstrative aspects, controller 154 may be configured to control, trigger, cause, and/or instruct the non-AP STA implemented by device 140 to determine the requested time shift duration, for example, based on a length of the unsuccessfully processed portion of the unreceived beacon, e.g., as described below.

In some demonstrative aspects, controller 154 may be configured to control, trigger, cause, and/or instruct the non-AP STA implemented by device 140 to determine the requested time shift duration, for example, based on a timing of the unsuccessfully processed portion of the unreceived beacon, e.g., as described below.

In some demonstrative aspects, controller 154 may be configured to control, trigger, cause, and/or instruct the non-AP STA implemented by device 140 to determine the requested time shift duration, for example, based on a successfully processed portion of an unreceived beacon, e.g., as described below.

In some demonstrative aspects, controller 154 may be configured to control, trigger, cause, and/or instruct the non-AP STA implemented by device 140 to determine the requested time shift duration, for example, based on a length of the successfully processed portion of an unreceived beacon, e.g., as described below.

In some demonstrative aspects, controller 154 may be configured to control, trigger, cause, and/or instruct the non-AP STA implemented by device 140 to determine the requested time shift duration, for example, based on a timing of the successfully processed portion of an unreceived beacon, e.g., as described below.

In some demonstrative aspects, controller 154 may be configured to control, trigger, cause, and/or instruct the non-AP STA implemented by device 140 to determine the requested time shift duration, for example, based on whether or not a beginning portion of an unreceived beacon is successfully processed by the non-AP STA, e.g., as described below.

In some demonstrative aspects, controller 154 may be configured to control, trigger, cause, and/or instruct the non-AP STA implemented by device 140 to determine the requested time shift duration to include a first time duration or a second time duration, for example, based on whether or not the beginning portion of the unreceived beacon is successfully processed by the non-AP STA, respectively, e.g., as described below.

In some demonstrative aspects, the first time duration may be longer than the second time duration, e.g., as described below.

In some demonstrative aspects, controller 154 may be configured to control, trigger, cause, and/or instruct the non-AP STA implemented by device 140 to determine the requested time shift duration, for example, based on detection of a beacon from an other AP, e.g., an AP implemented by device 160, for example, within a predefined time period from an expected beginning of an unreceived beacon from the AP 102, e.g., as described below.

In some demonstrative aspects, the predefined time period may be no longer than a beacon frame duration, e.g., as described below.

In other aspects, any other predefined time period may be utilized.

In some demonstrative aspects, controller 154 may be configured to control, trigger, cause, and/or instruct the non-AP STA implemented by device 140 to determine the requested time shift duration, for example, based on a timing of the detection of the beacon from the other AP 160, e.g., as described below.

In some demonstrative aspects, controller 154 may be configured to control, trigger, cause, and/or instruct the non-AP STA implemented by device 140 to determine the requested time shift duration, for example, based on a length of a successfully processed portion of the beacon from the other AP 160, e.g., as described below.

In some demonstrative aspects, controller 154 may be configured to control, trigger, cause, and/or instruct the non-AP STA implemented by device 140 to determine the requested time shift duration, for example, based on whether or not a beginning of a beacon from an other AP, e.g., the AP implemented by device 160, is received by the non-AP STA implemented by device 140 within a predefined time period from an expected beginning of an unreceived beacon from the AP 102, e.g., as described below.

In some demonstrative aspects, the predefined time period may be no longer than a beacon frame duration, e.g., as described below.

In other aspects, any other predefined time period may be utilized.

In some demonstrative aspects, controller 154 may be configured to control, trigger, cause, and/or instruct the non-AP STA implemented by device 140 to determine the requested time shift duration to include a first time duration or a second time duration, for example, based on whether or not the beginning of the beacon from the other AP 160 is received by the non-AP STA implemented by device 140 within the predefined time period from the expected beginning of the unreceived beacon from the AP 102, respectively, e.g., as described below.

In some demonstrative aspects, the first time duration may be shorter than the second time duration, e.g., as described below.

In some demonstrative aspects, controller 154 may be configured to control, trigger, cause, and/or instruct the non-AP STA implemented by device 140 to determine the requested time shift duration, for example, based on a length of an unsuccessfully processed portion of an unreceived beacon which is not successfully processed by non-AP STA implemented by device 140, e.g., as described below.

In some demonstrative aspects, controller 154 may be configured to control, trigger, cause, and/or instruct the non-AP STA implemented by device 140 to set the requested time shift duration to a predefined time shift duration, e.g., as described below.

In some demonstrative aspects, controller 154 may be configured to control, trigger, cause, and/or instruct the non-AP STA implemented by device 140 to set the requested time shift duration to a random time shift duration, e.g., as described below.

In some demonstrative aspects, controller 154 may be configured to control, trigger, cause, and/or instruct the non-AP STA implemented by device 140 to set the requested time shift duration according to any other additional or alternative criteria, definition and/or setting.

In some demonstrative aspects, controller 124 may be configured to control, trigger, cause, and/or instruct an AP implemented by device 102 to transmit a plurality of beacons according to a timing of a beacon transmission sequence of the AP 102, e.g., as described below.

In some demonstrative aspects, controller 124 may be configured to control, trigger, cause, and/or instruct the AP implemented by device 102 to process one or more fields of a frame received from a non-AP STA, e.g., frame 113 from device 140, for example, to determine a beacon transmission time shift request, which may be configured to request the AP 102 to shift the timing of the beacon transmission sequence of the AP 102, e.g., as described below.

In some demonstrative aspects, controller 124 may be configured to control, trigger, cause, and/or instruct the AP implemented by device 102 to process the one or more fields in a protected action frame received from the non-AP STA, e.g., frame 113 from device 140, for example, to determine the beacon transmission time shift request from device 140, e.g., as described below.

In some demonstrative aspects, controller 124 may be configured to control, trigger, cause, and/or instruct the AP implemented by device 102 to shift the timing of the beacon transmission sequence of the AP 102, for example, based on a determination that the beacon transmission time shift request from the non-AP STA is to be accepted, e.g., as described below.

In some demonstrative aspects, controller 124 may be configured to control, trigger, cause, and/or instruct the AP implemented by device 102 to schedule the sequence of beacons at a respective sequence of TBTTs, where two consecutive TBTTs in the sequence of TBTTs are separated by the beacon interval, e.g., as described below.

In some demonstrative aspects, the beacon transmission time shift request may include the beacon transmission delay request, which may be configured to request the AP 102 to delay the timing of the beacon transmission sequence of the AP 102, e.g., as described above.

In some demonstrative aspects, the beacon transmission time shift request may include the beacon transmission advance request, which may be configured to request the AP 102 to advance the timing of the beacon transmission sequence of the AP 102, e.g., as described above.

In some demonstrative aspects, controller 124 may be configured to control, trigger, cause, and/or instruct the AP implemented by device 102 to process the frame 113 to identify a beacon transmission time shift request IE including the one or more fields to configure the beacon transmission time shift request, e.g., as described below.

In some demonstrative aspects, controller 124 may be configured to control, trigger, cause, and/or instruct the AP implemented by device 102 to process the one or more fields of the frame 113, for example, to identify the duration value in the duration field, e.g., as described below.

In some demonstrative aspects, the duration value may be configured to indicate the requested time shift duration of the time shift to be applied to the timing of the beacon transmission sequence of the AP 102, e.g., as described above.

In some demonstrative aspects, the requested time shift duration may be no longer than half of the beacon interval of the beacon transmission sequence of the AP 102, e.g., as described above.

In some demonstrative aspects, controller 124 may be configured to control, trigger, cause, and/or instruct the AP implemented by device 102 to process the one or more fields of the frame 113, for example, to identify the minimal duration value in the minimal duration field, and/or the maximal duration value in the maximal duration field, e.g., as described below.

In some demonstrative aspects, the minimal duration value may be configured to indicate the requested minimal time shift duration of the time shift to be applied to the timing of the beacon transmission sequence of the AP 102, e.g., as described above.

In some demonstrative aspects, the maximal duration value may be configured to indicate the requested maximal time shift duration of the time shift to be applied to the timing of the beacon transmission sequence of the AP 102, e.g., as described above.

In some demonstrative aspects, controller 124 may be configured to control, trigger, cause, and/or instruct the AP implemented by device 102 to process the one or more fields of the frame 113, for example, to identify the priority value in the priority field, e.g., as described below.

In some demonstrative aspects, the priority value may be configured to indicate the priority level of the beacon transmission time shift request, e.g., as described above.

In some demonstrative aspects, controller 124 may be configured to control, trigger, cause, and/or instruct the AP implemented by device 102 to process the one or more fields of the frame 113, for example, to identify the requested time shift duration, and to shift the timing of the beacon transmission sequence of the AP 102, for example, based on the requested time shift duration, e.g., as described below.

In some demonstrative aspects, controller 124 may be configured to control, trigger, cause, and/or instruct the AP implemented by device 102 to determine an AP-decided time shift to be applied to the timing of the beacon transmission sequence of the AP 102, for example, based on the beacon transmission time shift request from device 140, e.g., as described below.

In some demonstrative aspects, controller 124 may be configured to control, trigger, cause, and/or instruct the AP implemented by device 102 to transmit a broadcast frame, for example, prior to shifting the timing of the beacon transmission sequence of the AP 102, e.g., as described below.

In some demonstrative aspects, the broadcast frame may include the time shift field, which may be configured to indicate the AP-decided time shift, e.g., as described above.

In some demonstrative aspects, controller 124 may be configured to control, trigger, cause, and/or instruct the AP implemented by device 102 to select whether to transmit the broadcast frame including the time shift field, for example, based on a duration of the AP-decided time shift, e.g., as described below.

In some demonstrative aspects, controller 124 may be configured to control, trigger, cause, and/or instruct the AP implemented by device 102 to configure the beacon-shift element in a beacon 117 to be transmitted from the AP 102 prior to shifting the timing of the beacon transmission sequence of the AP 102, e.g., as described below.

In some demonstrative aspects, the beacon-shift element may include the time shift field and/or the number-of beacon-intervals field, e.g., as described above.

In some demonstrative aspects, the time shift field may be configured to indicate the AP-decided time shift to applied to the timing of the beacon transmission sequence of the AP 102, e.g., as described above.

In some demonstrative aspects, the number-of beacon-intervals field may be configured to indicate a number of beacon-intervals until the AP 102 is to apply the AP-decided time shift, e.g., as described above.

In some demonstrative aspects, controller 124 may be configured to control, trigger, cause, and/or instruct the AP implemented by device 102 to select whether to transmit the beacon-shift element in the beacon 117, for example, based on a duration of the AP-decided time shift, e.g., as described below.

In some demonstrative aspects, controller 124 may be configured to control, trigger, cause, and/or instruct the AP implemented by device 102 to process a first frame received from a first non-AP STA, e.g., frame 113, to identify a first beacon transmission time shift request according to a first requested time shift duration, e.g., as described below.

In some demonstrative aspects, controller 124 may be configured to control, trigger, cause, and/or instruct the AP implemented by device 102 to process a second frame received from a second non-AP STA, for example, to identify a second beacon transmission time shift request according to a second requested time shift duration, e.g., as described below.

In some demonstrative aspects, controller 124 may be configured to control, trigger, cause, and/or instruct the AP implemented by device 102 to shift the timing of the beacon transmission sequence of the AP 102, for example, based on the first requested time shift duration and/or the second requested time shift duration, e.g., as described below.

In some demonstrative aspects, device 102, device 140, and/or device 160 may be configured to implement one or more operations and/or functionalities of a beacon transmission time shift mechanism, which may be configured to support a request from a non-AP STA, e.g., a client, to an AP to shift a timing of a beacon transmission sequence of the AP, e.g., as described below.

In some demonstrative aspects, the client, e.g., a non-AP STA implemented by device 140, may be “stuck” in the middle between a first AP and a second AP which are not aware of a hidden-node scenario, e.g., as they may not hear each other.

In some demonstrative aspects, the client, which may be associated with the first AP may be aware of the hidden-node scenario, e.g., as beacons from the first AP may not be received at the client.

In some demonstrative aspects, it may be defined that the client, e.g., the non-AP STA implemented by device 140, may ask the first AP, e.g., an AP implemented by device 102, to change its beacon transmission time, for example, based on a determination of the hidden-node scenario.

In some demonstrative aspects, it may be defined that if the client is not receiving beacons from the associated AP, but is still receiving fata-frames from the associated AP, it may be determined that this situation may be probably due to the hidden-node scenario.

In some demonstrative aspects, it may be defined that if the client is not receiving beacons from the associated AP, but is also not receiving data-frames from the associated AP, it may be determined that this situation is probably not related to the hidden-node scenario. For example, the AP may probably be too far from client, such that the beacons from the associated AP are not blocked by transmissions from an other AP.

In some demonstrative aspects, it may be defined that if the client is transmitting data to the associated AP and is not receiving an ACK frame from the associated AP following multiple retries, it may be determined that this situation is probably not related to hidden-node scenario. For example, the AP may probably be too far from client. For example, it may be defined that if the client receives the ACK frame, this situation may probably be due to a hidden-node scenario.

In some demonstrative aspects, it may be defined that, for example, as there may be multiple clients that are associated with an AP, and those clients may be in a power-save mode and will wake at an expected beacon transmission time, it may not be recommended that the AP will precede its beacon transmission time, e.g., as it may cause those clients to completely miss the beacon.

Therefore, it may be defined that the client may send a protected-action-frame to the AP to request the AP to delay its beacon transmission time by X milliseconds, e.g., where X value may be carried within the protected-action-frame.

In some demonstrative aspects, it may be defined that the client may use a length of a part of a beacon that has collided with the beacon from the associated AP, for example, to determine the length of the delay the client non-AP STA wants to suggest to the AP.

In some demonstrative aspects, it may be defined that if the client may not be able to identify the length of the part of the beacon that collided with the beacon from the associated AP, the client may perform one or more operations, e.g., as described below.

In some demonstrative aspects, it may be defined that the client may recommend to the AP a relatively longer delay time, for example, if the client identifies that the starts of the beacons from the associated AP are received, e.g., that the collision with beacons from other APs happens after the start of a beacon from the associated AP.

In some demonstrative aspects, it may be defined that the client may recommend to the AP a relatively shorter delay time, for example, if the client identifies that the start of a beacon from an other AP is received around an expected start time of beacons from the associated AP, e.g., that other beacons from other APs are received slightly before the expected start time of beacons from the associated AP.

In some demonstrative aspects, it may be defined that the client may recommend to the AP a default delay time, e.g., 3 msec or any other delay time, for example, in the case the client is not receiving the beacons from the associated AP.

In some demonstrative aspects, it may be defined that the AP may be free to accept or reject the recommendation from the client, for example, as the AP may have multiple clients, e.g., with multiple requests for beacon transmission time shifts.

In some demonstrative aspects, it may be defined that, if the AP decides to accept the recommendation from the client, and the recommended/selected delay time is relatively short, e.g., less than 5 msec, no further action may be requested from the AP, e.g., except for applying the delay to the beacon transmission time. For example, the AP may not be required to announce or to indicate the delay of the beacon transmission time.

In some demonstrative aspects, it may be defined that, if the AP is applying a longer delay, e.g., of 20 msec, the AP may send a broadcast protected-action-frame, which may target all associated clients with the AP, to indicate the planned delay.

In some demonstrative aspects, it may be defined that the broadcast protected-action-frame may be broadcasted as default, e.g., to announce or to indicate the delay in the beacon transmission time.

In some demonstrative aspects, when the AP delays the beacons by a short delay, e.g., several milliseconds, the clients may wait an extra time on the channel, and therefore no special indication is needed in the case of the short delay.

In some demonstrative aspects, when the AP delays the beacons by a long delay, the clients may give up before a beacon is received, and therefore, a special indication may be utilized.

In some demonstrative aspects, it may be defined that clients that receive the broadcast protected-action-frame that indicates a planned delay, may re-calibrate their beacon reception time.

In some demonstrative aspects, it may be defined that if an associated AP delays the beacon by several milliseconds, but following a short period, e.g., 2 minutes, the problem of collisions from another AP, e.g., in the hidden-node scenario, is repeated, a client may assume that the clock of the other AP is faster than the clock of the associated AP. For example, this scenario may mean that beacons from the other AP may move “backward”, e.g., compared to beacons from the associated AP. For example, as a result, the beacons from the other AP may stop being ahead of the beacons from the associated AP and may start to collide with them again.

In some demonstrative aspects, the client may ask the AP, e.g., once again, to delay its beacons, e.g., so the beacons will be “behind” the beacons from the other AP. However, this problem may be repeated again.

In some demonstrative aspects, it may be defined that, in this case, the client may suggest the AP to move to its earlier beacon slot/timing, e.g., which may be ahead of the timing of the beacons from the other AP. For example, this may let the beacons from the other AP to be transmitted after the beacons from the AP.

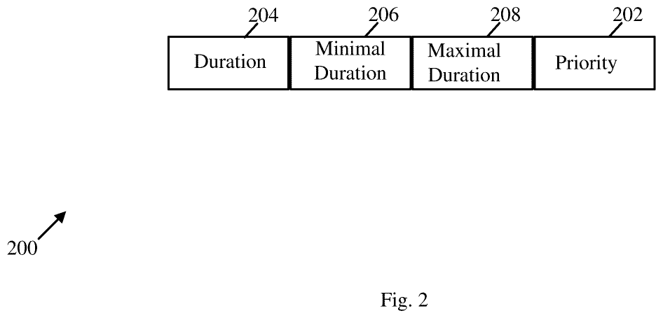

Reference is made to FIG. 2, which schematically illustrates a structure of a beacon transmission time shift request IE 200, in accordance with some demonstrative aspects.

For example, a non-AP STA, e.g., implemented by device 140 (FIG. 1), may be configured to transmit the frame 113 (FIG. 1) including the beacon transmission time shift request IE 200 to a beacon transmission time shift request, which may be configured to request an AP, e.g., the AP implemented by device 102 (FIG. 1), to shift a timing of a beacon transmission sequence of the AP.

For example, the AP, e.g., the AP implemented by device 102 (FIG. 1), may be configured to process the frame 113 (FIG. 1) including the beacon transmission time shift request IE 200, for example, to determine the beacon transmission time shift request from the non-AP STA, e.g., the non-AP STA implemented by device 140.

In some demonstrative aspects, as shown in FIG. 2, the beacon transmission time shift request IE 200 may include a duration field 204.

In some demonstrative aspects, duration field 204 may include a duration value, which may be configured to indicate a requested time shift duration of a time shift to be applied to the timing of the beacon transmission sequence of the AP.

In some demonstrative aspects, as shown in FIG. 2, the beacon transmission time shift request IE 200 may include a minimal duration field 206.

In some demonstrative aspects, minimal duration field 206 may include a minimal value, which may be configured to indicate a requested minimal time shift duration of the time shift to be applied to the timing of the beacon transmission sequence of the AP.

In some demonstrative aspects, as shown in FIG. 2, the beacon transmission time shift request IE 200 may include a maximal duration field 208.

In some demonstrative aspects, maximal duration field 208 may include a maximal value, which may be configured to indicate a requested maximal time shift duration of the time shift to be applied to the timing of the beacon transmission sequence of the AP.

In some demonstrative aspects, as shown in FIG. 2, the beacon transmission time shift request IE 200 may include a priority field 202.

In some demonstrative aspects, the priority field 202 may include a priority value, which may be configured to indicate a priority level of the beacon transmission time shift request.

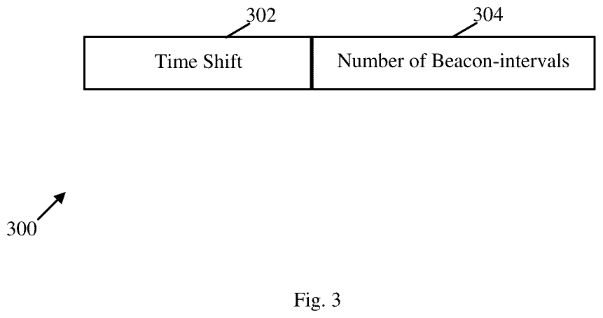

Reference is made to FIG. 3, which schematically illustrates a structure of a beacon-shift element 300, in accordance with some demonstrative aspects.

For example, an AP, e.g., the AP implemented by device 102 (FIG. 1), may be configured to transmit the beacon 117 (FIG. 1) including the beacon-shift element 300, for example, prior to shifting a timing of a beacon transmission sequence of the AP.

For example, a non-AP STA, e.g., the non-AP STA implemented by device 140 (FIG. 1), may be configured to process the beacon 117 (FIG. 1) including the beacon-shift element 300, for example, to identify the beacon-shift element 300, and to determine the AP-decided time shift to be applied to the timing of the beacon transmission sequence of the AP, for example, based the beacon-shift element 300.

In some demonstrative aspects, as shown in FIG. 3, the beacon-shift element 300 may include a time shift field 302, which may be configured to indicate an AP-decided time shift to be applied to the timing of the beacon transmission sequence of the AP.

In some demonstrative aspects, as shown in FIG. 3, the beacon-shift element 300 may include a number-of beacon-intervals field 304, which may be configured to indicate a number of beacon-intervals until the AP is to apply the AP-decided time shift.

In one example, the non-AP STA, e.g., the non-AP STA implemented by device 140 (FIG. 1), may be configured to determine the AP-decided time shift to be applied to the timing of the beacon transmission sequence of the AP, for example, based on the time shift field 302 in the beacon-shift element 300.

In one example, the non-AP STA, e.g., the non-AP STA implemented by device 140 (FIG. 1), may be configured to determine the number of beacon-intervals until the AP is to apply the AP-decided time shift, for example, based on the number-of beacon-intervals field 304 in the beacon-shift element 300.

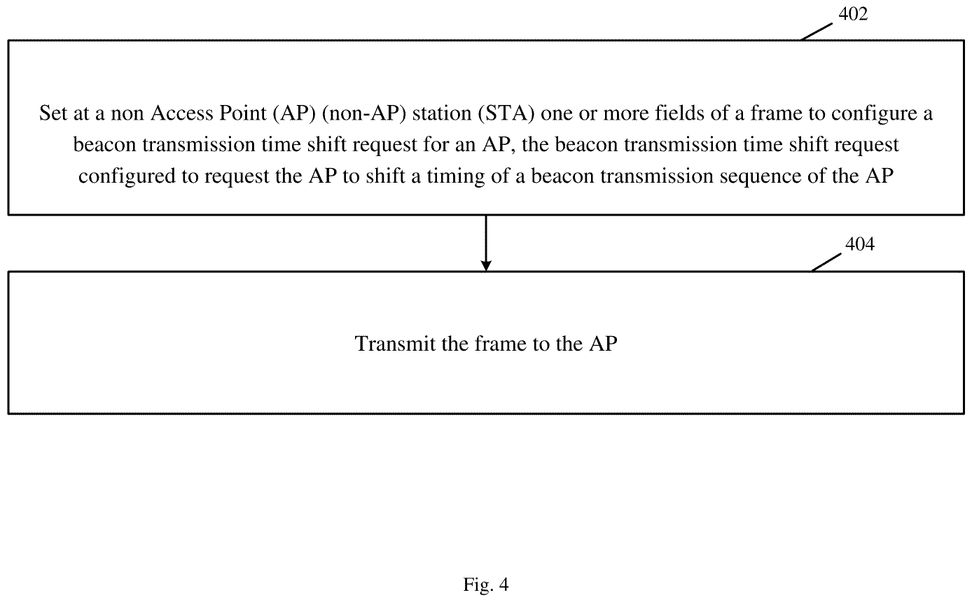

Reference is made to FIG. 4, which schematically illustrates a method of a beacon transmission time shift, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include setting at a non-SP STA one or more fields of a frame to configure a beacon transmission time shift request for an AP. For example, the beacon transmission time shift request may be configured to request the AP to shift a timing of a beacon transmission sequence of the AP. For example, controller 154 (FIG. 1) may be configured to cause, trigger, and/or control the non-AP STA implemented by device 140 (FIG. 1) to set the one or more fields of the frame 113 (FIG. 1) to configure the beacon transmission time shift request for the AP implemented by device 102 (FIG. 1), e.g., as described above.

As indicated at block 404, the method may include transmitting the frame to the AP. For example, controller 154 (FIG. 1) may be configured to cause, trigger, and/or control the non-AP STA implemented by device 140 (FIG. 1) to transmit the frame 113 (FIG. 1) to the AP implemented by device 102 (FIG. 1), e.g., as described above.

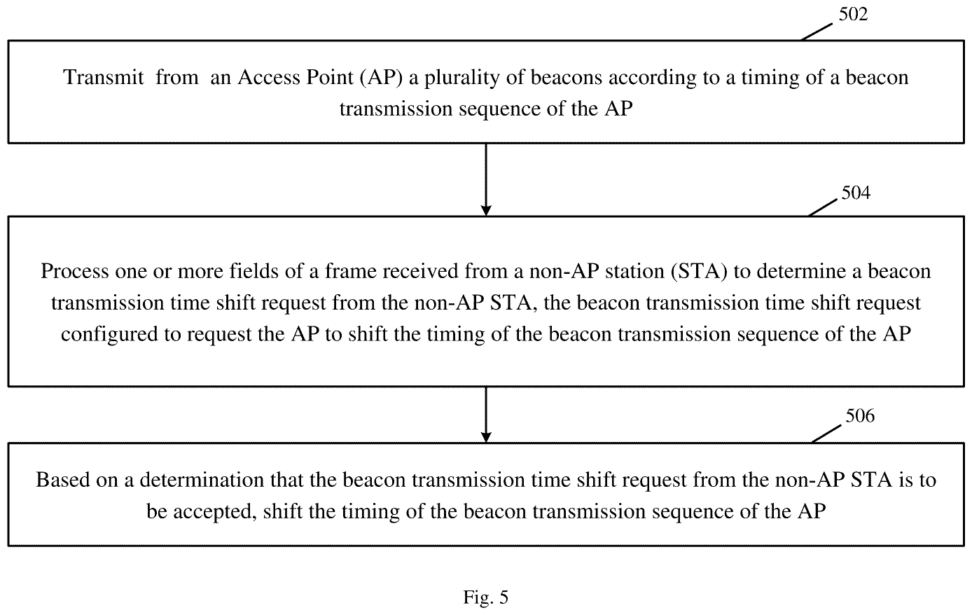

Reference is made to FIG. 5, which schematically illustrates a method of a beacon transmission time shift, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include transmitting from an AP a plurality of beacons according to a timing of a beacon transmission sequence of the AP For example, controller 124 (FIG. 1) may be configured to cause, trigger, and/or control the AP implemented by device 102 (FIG. 1) to transmit the plurality of beacons according to the timing of the beacon transmission sequence of the AP, e.g., as described above.

As indicated at block 504, the method may include processing one or more fields of a frame received from a non-AP STA to determine a beacon transmission time shift request from the non-AP STA. For example, the beacon transmission time shift request may be configured to request the AP to shift the timing of the beacon transmission sequence of the AP. For example, controller 124 (FIG. 1) may be configured to cause, trigger, and/or control the AP implemented by device 102 (FIG. 1) to process the one or more fields of the frame 113 (FIG. 1) received from the non-AP STA implemented by device 140 (FIG. 1) to determine the beacon transmission time shift request from the non-AP STA implemented by device 140 (FIG. 1), e.g., as described above.

As indicated at block 506, the method may include shifting the timing of the beacon transmission sequence of the AP, for example, based on a determination that the beacon transmission time shift request from the non-AP STA is to be accepted. For example, controller 124 (FIG. 1) may be configured to cause, trigger, and/or control the AP implemented by device 102 (FIG. 1) to, based on the determination that the beacon transmission time shift request from device 140 (FIG. 1) is to be accepted, shift the timing of the beacon transmission sequence of the AP implemented by device 102 (FIG. 1), e.g., as described above.

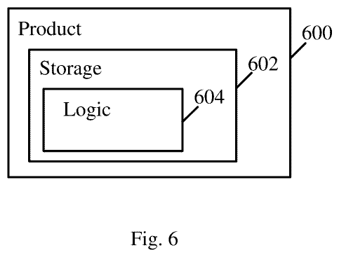

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause a non Access Point (AP) (non-AP) station (STA) to set one or more fields of a frame to configure a beacon transmission time shift request for an AP, the beacon transmission time shift request configured to request the AP to shift a timing of a beacon transmission sequence of the AP; and transmit the frame to the AP; and a memory to store information processed by the processor.

Example 2 includes the subject matter of Example 1, and optionally, wherein the apparatus is configured to cause the non-AP STA to determine whether a beacon transmission time shift is to be requested from the AP based on one or more unreceived beacons from the AP, the one or more unreceived beacons from the AP comprising one or more beacons which are scheduled to be received by the non-AP STA from the AP according to the beacon transmission sequence of the AP and which are not successfully received by the non-AP STA; and based on a determination that the beacon transmission time shift is to be requested, transmit the frame comprising the one or more fields set to indicate the beacon transmission time shift request.

Example 3 includes the subject matter of Example 2, and optionally, wherein the apparatus is configured to cause the non-AP STA to set the one or more fields of the frame based on a requested time shift duration of a time shift to be applied to the timing of the beacon transmission sequence of the AP.

Example 4 includes the subject matter of Example 3, and optionally, wherein the apparatus is configured to cause the non-AP STA to determine the requested time shift duration based on the one or more unreceived beacons.

Example 5 includes the subject matter of Example 4, and optionally, wherein the apparatus is configured to cause the non-AP STA to determine the requested time shift duration based on a count of the one or more unreceived beacons.

Example 6 includes the subject matter of Example 4 or 5, and optionally, wherein the apparatus is configured to cause the non-AP STA to determine the requested time shift duration based on a count of a plurality of successive unreceived beacons.

Example 7 includes the subject matter of any one of Examples 3-6, and optionally, wherein the apparatus is configured to cause the non-AP STA to determine the requested time shift duration based on an unsuccessfully processed portion of an unreceived beacon.

Example 8 includes the subject matter of Example 7, and optionally, wherein the apparatus is configured to cause the non-AP STA to determine the requested time shift duration based on a length of the unsuccessfully processed portion of the unreceived beacon.

Example 9 includes the subject matter of Example 7 or 8, and optionally, wherein the apparatus is configured to cause the non-AP STA to determine the requested time shift duration based on a timing of the unsuccessfully processed portion of the unreceived beacon.

Example 10 includes the subject matter of any one of Examples 3-9, and optionally, wherein the apparatus is configured to cause the non-AP STA to determine the requested time shift duration based on a successfully processed portion of an unreceived beacon.

Example 11 includes the subject matter of Example 10, and optionally, wherein the apparatus is configured to cause the non-AP STA to determine the requested time shift duration based on a length of the successfully processed portion of the unreceived beacon.

Example 12 includes the subject matter of Example 10 or 11, and optionally, wherein the apparatus is configured to cause the non-AP STA to determine the requested time shift duration based on a timing of the successfully processed portion of the unreceived beacon.

Example 13 includes the subject matter of any one of Examples 3-12, and optionally, wherein the apparatus is configured to cause the non-AP STA to determine the requested time shift duration based on whether or not a beginning portion of an unreceived beacon is successfully processed by the non-AP STA.

Example 14 includes the subject matter of Example 13, and optionally, wherein the apparatus is configured to cause the non-AP STA to determine the requested time shift duration comprising a first time duration or a second time duration based on whether or not the beginning portion of the unreceived beacon is successfully processed by the non-AP STA, respectively, the first time duration is longer than the second time duration.

Example 15 includes the subject matter of any one of Examples 3-14, and optionally, wherein the apparatus is configured to cause the non-AP STA to determine the requested time shift duration based on detection of a beacon from an other AP within a predefined time period from an expected beginning of an unreceived beacon from the AP.

Example 16 includes the subject matter of Example 15, and optionally, wherein the apparatus is configured to cause the non-AP STA to determine the requested time shift duration based on a timing of the detection of the beacon from the other AP.

Example 17 includes the subject matter of Example 15 or 16, and optionally, wherein the apparatus is configured to cause the non-AP STA to determine the requested time shift duration based on a length of a successfully processed portion of the beacon from the other AP.

Example 18 includes the subject matter of any one of Examples 15-17, and optionally, wherein the predefined time period is no longer than a beacon frame duration.

Example 19 includes the subject matter of any one of Examples 3-18, and optionally, wherein the apparatus is configured to cause the non-AP STA to determine the requested time shift duration based on whether or not a beginning of a beacon from an other AP is received by the non-AP STA within a predefined time period from an expected beginning of an unreceived beacon from the AP.

Example 20 includes the subject matter of Example 19, and optionally, wherein the apparatus is configured to cause the non-AP STA to determine the requested time shift duration comprising a first time duration or a second time duration based on whether or not the beginning of the beacon from the other AP is received by the non-AP STA within the predefined time period from the expected beginning of the unreceived beacon from the AP, respectively, the first time duration is shorter than the second time duration.

Example 21 includes the subject matter of Example 19 or 20, and optionally, wherein the predefined time period is no longer than a beacon frame duration.

Example 22 includes the subject matter of any one of Examples 3-21, and optionally, wherein the apparatus is configured to cause the non-AP STA to determine the requested time shift duration based on a length of an unsuccessfully processed portion of an unreceived beacon which is not successfully processed by the non-AP STA.

Example 23 includes the subject matter of Example 3, and optionally, wherein the apparatus is configured to cause the non-AP STA to set the requested time shift duration to a predefined time shift duration.

Example 24 includes the subject matter of Example 3, and optionally, wherein the apparatus is configured to cause the non-AP STA to set the requested time shift duration to a random time shift duration.

Example 25 includes the subject matter of any one of Examples 2-24, and optionally, wherein the apparatus is configured to cause the non-AP STA to determine that the beacon transmission time shift is to be requested based on a determination that one or more non-beacon transmissions from the AP are successfully received by the non-AP STA during a time interval between an unreceived beacon from the AP and a time of an expected beacon adjacent to the unreceived beacon in the beacon transmission sequence of the AP.

Example 26 includes the subject matter of Example 25, and optionally, wherein the one or more non-beacon transmissions from the AP comprises one or more data frames from the AP.

Example 27 includes the subject matter of Example 25 or 26, and optionally, wherein the one or more non-beacon transmissions from the AP comprises one or more Acknowledge (Ack) frames to Acknowledge an uplink transmission from the non-AP to the AP.

Example 28 includes the subject matter of any one of Examples 2-27, and optionally, wherein the apparatus is configured to cause the non-AP STA to determine that the beacon transmission time shift is not to be requested based on a determination that one or more expected non-beacon transmissions from the AP are not successfully received by the non-AP STA during a time interval between an unreceived beacon from the AP and a time of an expected beacon adjacent to the unreceived beacon in the beacon transmission sequence of the AP.

Example 29 includes the subject matter of Example 28, and optionally, wherein the one or more non-beacon transmissions from the AP comprises one or more data frames from the AP.

Example 30 includes the subject matter of Example 28 or 29, and optionally, wherein the one or more non-beacon transmissions from the AP comprises one or more Acknowledge (Ack) frames to Acknowledge an uplink transmission from the non-AP to the AP.

Example 31 includes the subject matter of any one of Examples 2-30, and optionally, wherein the apparatus is configured to cause the non-AP STA to determine whether the beacon transmission time shift is to be requested from the AP according to a hidden-node criterion applied with respect to the one or more unreceived beacons from the AP, the hidden-node criterion configured to result in the determination that the beacon transmission time shift is to be requested when the one or more unreceived beacons from the AP are not successfully received by the non-AP STA due to collision with transmissions from another AP.

Example 32 includes the subject matter of any one of Examples 1-31, and optionally, wherein the apparatus is configured to cause the non-AP STA to set the one or more fields of the frame comprising a duration value in a duration field, the duration value configured to indicate a requested time shift duration of a time shift to be applied to the timing of the beacon transmission sequence of the AP.

Example 33 includes the subject matter of Example 32, and optionally, wherein the requested time shift duration is no longer than half of a beacon interval of the beacon transmission sequence of the AP.

Example 34 includes the subject matter of any one of Examples 1-33, and optionally, wherein the apparatus is configured to cause the non-AP STA to set the one or more fields of the frame comprising at least one of a minimal duration value in a minimal duration field, or a maximal duration value in a maximal duration field, wherein the minimal duration value is configured to indicate a requested minimal time shift duration of a time shift to be applied to the timing of the beacon transmission sequence of the AP, the maximal duration value configured to indicate a requested maximal time shift duration of the time shift to be applied to the timing of the beacon transmission sequence of the AP.

Example 35 includes the subject matter of any one of Examples 1-34, and optionally, wherein the apparatus is configured to cause the non-AP STA to set the one or more fields of the frame comprising a priority value in a priority field, the priority value configured to indicate a priority level of the beacon transmission time shift request.

Example 36 includes the subject matter of any one of Examples 1-35, and optionally, wherein the apparatus is configured to cause the non-AP STA to process a broadcast frame from the AP to identify an AP-decided time shift to be applied to the timing of the beacon transmission sequence of the AP.

Example 37 includes the subject matter of any one of Examples 1-36, and optionally, wherein the apparatus is configured to cause the non-AP STA to process a received beacon from the AP to identify a beacon-shift element, to determine an AP-decided time shift to be applied to the timing of the beacon transmission sequence of the AP based on a time shift field in the beacon-shift element, and to determine a number of beacon-intervals until the AP is to apply the AP-decided time shift based on a number-of beacon-intervals field in the beacon-shift element.

Example 38 includes the subject matter of any one of Examples 1-37, and optionally, wherein the beacon transmission time shift request comprises a beacon transmission delay request configured to request the AP to delay the timing of the beacon transmission sequence of the AP.

Example 39 includes the subject matter of any one of Examples 1-37, and optionally, wherein the beacon transmission time shift request comprises a beacon transmission advance request configured to request the AP to advance the timing of the beacon transmission sequence of the AP.

Example 40 includes the subject matter of any one of Examples 1-39, and optionally, wherein the beacon transmission sequence of the AP comprises a sequence of beacons scheduled at a respective sequence of Target Beacon Transmission Times (TBTTs), wherein two consecutive TBTTs in the sequence of TBTTs are separated by a beacon interval.

Example 41 includes the subject matter of any one of Examples 1-40, and optionally, wherein the frame comprises a beacon transmission time shift request Information Element (IE) comprising the one or more fields to configure the beacon transmission time shift request.

Example 42 includes the subject matter of any one of Examples 1-41, and optionally, wherein the frame comprises a protected action frame.

Example 43 includes the subject matter of any one of Examples 1-42, and optionally, comprising a radio to transmit the frame.

Example 44 includes the subject matter of Example 43, and optionally, comprising one or more antennas connected to the radio, and another processor to execute instructions of an operating system.

Example 45 includes an apparatus comprising a processor configured to cause an Access Point (AP) to transmit a plurality of beacons according to a timing of a beacon transmission sequence of the AP; process one or more fields of a frame received from a non-AP station (STA) to determine a beacon transmission time shift request from the non-AP STA, the beacon transmission time shift request configured to request the AP to shift the timing of the beacon transmission sequence of the AP; and based on a determination that the beacon transmission time shift request from the non-AP STA is to be accepted, shift the timing of the beacon transmission sequence of the AP; and a memory to store information processed by the processor.

Example 46 includes the subject matter of Example 45, and optionally, wherein the apparatus is configured to cause the AP to process the one or more fields of the frame to identify a requested time shift duration, and to shift the timing of the beacon transmission sequence of the AP based on the requested time shift duration.

Example 47 includes the subject matter of Example 45 or 46, and optionally, wherein the apparatus is configured to cause the AP to determine an AP-decided time shift to be applied to the timing of the beacon transmission sequence of the AP based on the beacon transmission time shift request from the non-AP STA.

Example 48 includes the subject matter of Example 47, and optionally, wherein the apparatus is configured to cause the AP to transmit a broadcast frame prior to shifting the timing of the beacon transmission sequence of the AP, the broadcast frame comprising a time shift field configured to indicate the AP-decided time shift.

Example 49 includes the subject matter of Example 48, and optionally, wherein the apparatus is configured to cause the AP to select whether to transmit the broadcast frame comprising the time shift field based on a duration of the AP-decided time shift.

Example 50 includes the subject matter of any one of Examples 45-49, and optionally, wherein the apparatus is configured to cause the AP to configure a beacon-shift element in a beacon to be transmitted from the AP prior to shifting the timing of the beacon transmission sequence of the AP, wherein the beacon-shift element comprises a time shift field and a number-of beacon-intervals field, the time shift field configured to indicate an AP-decided time shift to applied to the timing of the beacon transmission sequence of the AP, the number-of beacon-intervals field configured to indicate a number of beacon-intervals until the AP is to apply the AP-decided time shift.

Example 51 includes the subject matter of Example 50, and optionally, wherein the apparatus is configured to cause the AP to select whether to transmit the beacon-shift element in the beacon based on a duration of the AP-decided time shift.

Example 52 includes the subject matter of any one of Examples 45-51, and optionally, wherein the apparatus is configured to cause the AP to process a first frame received from a first non-AP STA to identify a first beacon transmission time shift request according to a first requested time shift duration; process a second frame received from a second non-AP STA to identify a second beacon transmission time shift request according to a second requested time shift duration; and shift the timing of the beacon transmission sequence of the AP based on at least one of the first requested time shift duration or the second requested time shift duration.

Example 53 includes the subject matter of any one of Examples 45-52, and optionally, wherein the apparatus is configured to cause the AP to process the one or more fields of the frame to identify a duration value in a duration field, the duration value configured to indicate a requested time shift duration of a time shift to be applied to the timing of the beacon transmission sequence of the AP.

Example 54 includes the subject matter of Example 53, and optionally, wherein the requested time shift duration is no longer than half of a beacon interval of the beacon transmission sequence of the AP.

Example 55 includes the subject matter of any one of Examples 45-54, and optionally, wherein the apparatus is configured to cause the AP to process the one or more fields of the frame to identify at least one of a minimal duration value in a minimal duration field, or a maximal duration value in a maximal duration field, wherein the minimal duration value is configured to indicate a requested minimal time shift duration of a time shift to be applied to the timing of the beacon transmission sequence of the AP, the maximal duration value configured to indicate a requested maximal time shift duration of the time shift to be applied to the timing of the beacon transmission sequence of the AP.

Example 56 includes the subject matter of any one of Examples 45-55, and optionally, wherein the apparatus is configured to cause the AP to process the one or more fields of the frame to identify a priority value in a priority field, the priority value configured to indicate a priority level of the beacon transmission time shift request.

Example 57 includes the subject matter of any one of Examples 45-56, and optionally, wherein the beacon transmission time shift request comprises a beacon transmission delay request configured to request the AP to delay the timing of the beacon transmission sequence of the AP.

Example 58 includes the subject matter of any one of Examples 45-57, and optionally, wherein the beacon transmission time shift request comprises a beacon transmission advance request configured to request the AP to advance the timing of the beacon transmission sequence of the AP.

Example 59 includes the subject matter of any one of Examples 45-58, and optionally, wherein the apparatus is configured to cause the AP to schedule the sequence of beacons at a respective sequence of Target Beacon Transmission Times (TBTTs), wherein two consecutive TBTTs in the sequence of TBTTs are separated by a beacon interval.

Example 60 includes the subject matter of any one of Examples 45-59, and optionally, wherein the frame comprises a beacon transmission time shift request Information Element (IE) comprising the one or more fields to configure the beacon transmission time shift request.

Example 61 includes the subject matter of any one of Examples 45-60, and optionally, wherein the frame comprises a protected action frame.

Example 62 includes the subject matter of any one of Examples 45-61, and optionally, comprising a radio to transmit the transmit the plurality of beacons, and to receive the frame from the non-AP STA.

Example 63 includes the subject matter of Example 62, and optionally, comprising one or more antennas connected to the radio, and another processor to execute instructions of an operating system.

Example 64 includes a wireless communication device comprising the apparatus of any of Examples 1-63.

Example 65 includes a mobile device comprising the apparatus of any of Examples 1-63.

Example 66 includes an apparatus comprising means for executing any of the described operations of any of Examples 1-63.

Example 67 includes a product comprising one or more tangible computer-readable non-transitory storage media comprising instructions operable to, when executed by at least one processor, enable the at least one processor to cause any of the described operations of any of Examples 1-63.

Example 68 includes an apparatus comprising: a memory interface; and processing circuitry configured to: perform any of the described operations of any of Examples 1-63.

Example 69 includes a method comprising any of the described operations of any of Examples 1-63.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a non Access Point (AP) (non-AP) station (STA) to:
set one or more fields of a frame to configure a beacon transmission time shift request for an AP, the beacon transmission time shift request configured to request the AP to shift a timing of a beacon transmission sequence of the AP; and
transmit the frame to the AP; and
a memory to store information processed by the processor.

2. The apparatus of claim 1 configured to cause the non-AP STA to:
determine whether a beacon transmission time shift is to be requested from the AP based on one or more unreceived beacons from the AP, the one or more unreceived beacons from the AP comprising one or more beacons which are scheduled to be received by the non-AP STA from the AP according to the beacon transmission sequence of the AP and which are not successfully received by the non-AP STA; and
based on a determination that the beacon transmission time shift is to be requested, transmit the frame comprising the one or more fields set to indicate the beacon transmission time shift request.

3. The apparatus of claim 2 configured to cause the non-AP STA to set the one or more fields of the frame based on a requested time shift duration of a time shift to be applied to the timing of the beacon transmission sequence of the AP.

4. The apparatus of claim 3 configured to cause the non-AP STA to determine the requested time shift duration based on the one or more unreceived beacons.

5. The apparatus of claim 3 configured to cause the non-AP STA to determine the requested time shift duration based on an unsuccessfully processed portion of an unreceived beacon.

6. The apparatus of claim 3 configured to cause the non-AP STA to determine the requested time shift duration based on a successfully processed portion of an unreceived beacon.

7. The apparatus of claim 3 configured to cause the non-AP STA to determine the requested time shift duration based on detection of a beacon from an other AP within a predefined time period from an expected beginning of an unreceived beacon from the AP.

8. The apparatus of claim 3 configured to cause the non-AP STA to set the requested time shift duration to a random time shift duration.

9. The apparatus of claim 2 configured to cause the non-AP STA to determine that the beacon transmission time shift is to be requested based on a determination that one or more non-beacon transmissions from the AP are successfully received by the non-AP STA during a time interval between an unreceived beacon from the AP and a time of an expected beacon adjacent to the unreceived beacon in the beacon transmission sequence of the AP.

10. The apparatus of claim 1 configured to cause the non-AP STA to set the one or more fields of the frame comprising a duration value in a duration field, the duration value configured to indicate a requested time shift duration of a time shift to be applied to the timing of the beacon transmission sequence of the AP.

11. The apparatus of claim 1 configured to cause the non-AP STA to set the one or more fields of the frame comprising at least one of a minimal duration value in a minimal duration field, or a maximal duration value in a maximal duration field, wherein the minimal duration value is configured to indicate a requested minimal time shift duration of a time shift to be applied to the timing of the beacon transmission sequence of the AP, the maximal duration value configured to indicate a requested maximal time shift duration of the time shift to be applied to the timing of the beacon transmission sequence of the AP.

12. The apparatus of claim 1 configured to cause the non-AP STA to set the one or more fields of the frame comprising a priority value in a priority field, the priority value configured to indicate a priority level of the beacon transmission time shift request.

13. The apparatus of claim 1 configured to cause the non-AP STA to process a broadcast frame from the AP to identify an AP-decided time shift to be applied to the timing of the beacon transmission sequence of the AP.

14. The apparatus of claim 1 comprising a radio to transmit the frame, one or more antennas connected to the radio, and another processor to execute instructions of an operating system.

15. An apparatus comprising:
a processor configured to cause an Access Point (AP) to:
transmit a plurality of beacons according to a timing of a beacon transmission sequence of the AP;
process one or more fields of a frame received from a non-AP station (STA) to determine a beacon transmission time shift request from the non-AP STA, the beacon transmission time shift request configured to request the AP to shift the timing of the beacon transmission sequence of the AP; and
based on a determination that the beacon transmission time shift request from the non-AP STA is to be accepted, shift the timing of the beacon transmission sequence of the AP; and
a memory to store information processed by the processor.

16. The apparatus of claim 15 configured to cause the AP to process the one or more fields of the frame to identify a requested time shift duration, and to shift the timing of the beacon transmission sequence of the AP based on the requested time shift duration.

17. The apparatus of claim 15 configured to cause the AP to determine an AP-decided time shift to be applied to the timing of the beacon transmission sequence of the AP based on the beacon transmission time shift request from the non-AP STA.

18. The apparatus of claim 17 configured to cause the AP to transmit a broadcast frame prior to shifting the timing of the beacon transmission sequence of the AP, the broadcast frame comprising a time shift field configured to indicate the AP-decided time shift.

19. One or more tangible computer-readable non-transitory storage media comprising instructions operable to, when executed by at least one processor, enable the at least one processor to cause a non Access Point (AP) (non-AP) station (STA) to:
set one or more fields of a frame to configure a beacon transmission time shift request for an AP, the beacon transmission time shift request configured to request the AP to shift a timing of a beacon transmission sequence of the AP; and
transmit the frame to the AP.

20. The one or more tangible computer-readable non-transitory storage media of claim 19, wherein the instructions, when executed cause the non-AP STA to:
determine whether a beacon transmission time shift is to be requested from the AP based on one or more unreceived beacons from the AP, the one or more unreceived beacons from the AP comprising one or more beacons which are scheduled to be received by the non-AP STA from the AP according to the beacon transmission sequence of the AP and which are not successfully received by the non-AP STA; and
based on a determination that the beacon transmission time shift is to be requested, transmit the frame comprising the one or more fields set to indicate the beacon transmission time shift request.
